(19) United States
(12) Patent Application Publication
(10) Pub. No.: US 2025/0074797 A1
(43) Pub. Date: Mar. 6, 2025

(54) DEVICES, SYSTEMS AND METHODS FOR FLUID TREATMENT

(71) Applicants: Fraunhofer-Gesellschaft zur Förderung der angewand, München (DE); Fraunhofer USA, Inc., Plymouth, MI (US)

(72) Inventors: Daniel SCHMITT, Sulzbach (DE); Steffen TRETBAR, Sulzbach (DE); Michael Frank BECKER, East Lansing, MI (US); Suzanne WITT, East Lansing, MI (US)

(21) Appl. No.: 18/726,525

(22) PCT Filed: Jan. 4, 2023
(86) PCT No.: PCT/US2023/060056

§ 371 Date: Jul. 3, 2024

Related U.S. Application Data
(60) Provisional application No. 63/266,370, filed on Jan. 4, 2022.

(51) Int. Cl. C02F 1/467; C02F 1/36; C02F 1/461

(52) U.S. Cl. CPC C02F 1/4672; C02F 1/36; C02F 1/46109; C02F 2001/46147; C02F 2001/46171; C02F 2301/08; C02F 2303/12

(57) ABSTRACT

The present disclosure relates to fluid treatment. In particular, examples of the present disclosure relate to devices, systems and methods for fluid treatment combining electrochemical oxidation treatment and sonication treatment of fluids.

### FIELD

The present disclosure relates to fluid treatment. In particular, examples of the present disclosure relate to devices, systems and methods for fluid treatment. For example, examples of the present disclosure may be used for treating contaminated fluids.

### BACKGROUND

Chemical substances like Per- and polyFluoroAlkyl Substances (PFASs) accumulate in soil, surface water or ground water. Methods are reported to remove the chemicals. However, the chemicals still accumulate in the waste. Further, methods are reported to remediate and destroy the chemicals. Energy consumption and running costs of conventional methods prevent from broader use.

Remediation of the chemicals is done based on singular effects like Electrochemical Oxidation (EO). However, there is no widely used destructive technique. Incineration is likely the most common. However, incineration is under increased scrutiny due to air contamination. Remediation traditionally focuses on removal rather than destruction, which creates a closed waste stream because the PFAS is never destroyed.

Treatment of contaminated fluid streams by EO or sonolysis alone is done conventionally. A combination of both methods is done conventionally by splitting the stream, treating the separated streams at individual treatment stations with a single method before recombination. Daisy-chaining of treatment stations is done conventionally by using the individual effect sequentially. Foam generation is described as reducing efficiency of the EO. Utilizing hydrodynamic and acoustic cavitation as a sequential process is done conventionally. A combination of different effects (e.g., EO and sonolysis) is advantageous for chemical reduction in fluids. However, splitting and recombining fluid streams requires complex and spacious tubing systems. Fluid streaming conditions are difficult to control under such conditions and scaling from laboratory to field conditions requires either enlarging hydraulic diameter or using several of the complex systems in parallel further increasing complexity and required space. Electrolytic driven foaming (O₂ and H₂ production) reduces efficiency—even more in complex tubing systems where foam can accumulate. A general interference of ultrasound and electrochemistry (acoustic streaming, bubble creation, . . . ) is described as a positive effect, but a close or even coincident integration is not considered at least partly due to the well known erosion effect by ultrasonic cavitation. This would limit lifetime of the electrodes used for EO.

Hence, there may be a demand for improved fluid treatment, in particular improved treatment of fluid containing a PFAS.

### SUMMARY

The demand may be satisfied by the subject-matter of the appended claims.

According to a first aspect, the present disclosure provides a device for fluid treatment. The device comprises a first surface for contacting and electrochemical oxidation treatment of the fluid. In addition, the device comprises a second surface for contacting and sonication treatment of the fluid. The first surface and the second surface are arranged on opposite sides of the device.

According to a second aspect, the present disclosure provides a first system for fluid treatment. The system comprises a first device for fluid treatment according to the present disclosure and a second device for fluid treatment according to the present disclosure. The second device is spaced apart from the first device to form a fluid channel for the fluid between the first device and the second device. Either the first surface of the first device faces the first surface of the second device or the second surface of the first device faces the second surface of the second device.

According to a third aspect, the present disclosure provides a second system for fluid treatment. The system comprises a first device for fluid treatment according to the present disclosure, a second device for fluid treatment according to the present disclosure, a third device for fluid treatment according to the present disclosure and a fourth device for fluid treatment according to the present disclosure. The second device is spaced apart from the first device to form a first fluid channel for the fluid between the first device and the second device. The fourth device is spaced apart from the third device to form second fluid channel for the fluid between the third device and the fourth device. The third device follows the first device along a flow direction of fluid and the fourth device follows the second device along the flow direction of the fluid such that the fluid first passes through the first fluid channel and subsequently passes through the second fluid channel. Either the first surface of the first device faces the first surface of the second device such that the first fluid channel is formed between first surface of the first device and the first surface of the second device or the second surface of the first device faces the second surface of the second device such that the first fluid channel is formed between second surface of the first device and the second surface of the second device. If the first surface of the first device faces the first surface of the second device, the second surface of the third device faces the second surface of the fourth device such that the second fluid channel is formed between second surface of the third device and the second surface of the fourth device. If the second surface of the first device faces the second surface of the second device, the first surface of the third device faces the first surface of the fourth device such that the second fluid channel is formed between first surface of the third device and the first surface of the fourth device.

According to a fourth aspect, the present disclosure provides a third system for fluid treatment. The system comprises a pipe comprising an electrically conductive inner wall. Additionally, the system comprises at least one device for fluid treatment according to the present disclosure. The at least one device is spaced apart from the inner wall of the pipe to form a first fluid channel between at least one device and the inner wall of the pipe. The respective first surface of the at least one device faces the inner wall of the pipe. The at least one device is arranged between the first fluid channel and a second fluid channel. The at least one device and the inner wall of the pipe are configured to form an electric field between the respective first surface of the at least one device and the inner wall of the pipe for electrochemical oxidation treatment of the fluid passing the first fluid channel. The at least one device is configured to emit ultrasonic waves for sonication treatment of the fluid passing the second fluid channel at the respective second surface.

According to a fifth aspect, the present disclosure provides a fourth system for fluid treatment. The system comprises a first device for fluid treatment and a second device for fluid treatment. The second device for fluid treatment is spaced apart from the first device for fluid treatment to form a fluid channel for a fluid between the first device for fluid treatment and the second device for fluid treatment. The first device comprises a first electrically conductive membrane and at least one first ultrasonic actuator coupled to the first membrane. The second device comprises a second electrically conductive membrane and at least one second ultrasonic actuator coupled to the second membrane. The first device and the second device are configured to selectively form an electric field between the first membrane and the second membrane for electrochemical oxidation treatment of the fluid passing the fluid channel. The at least one first ultrasonic actuator and the at least one second ultrasonic actuator are configured to selectively generate ultrasonic waves for the sonication treatment of the fluid passing the fluid channel.

According to a sixth aspect, the present disclosure provides a fifth system for fluid treatment. The system comprises a plurality of anodes and cathodes arranged alternatingly to form a respective electric field between succeeding ones of the plurality of anodes and cathodes for electrochemical oxidation treatment of a fluid. Additionally, the system comprises an actuator layer comprising at least one ultrasonic actuator configured to generate ultrasonic waves for sonication treatment of the fluid. The actuator layer is arranged in series with the plurality of anodes and cathodes and follows the plurality of anodes and cathodes along a flow direction of the fluid.

According to a seventh aspect, the present disclosure provides a method for fluid treatment. The method comprising inputting a fluid into a system for fluid treatment according to the present disclosure. Additionally, the method comprises treating the fluid using the system for fluid treatment.

The device, the systems and the method for fluid treatment according to the present disclosure may allow improved treatment (e.g., purification) of the fluid by combining EO treatment and sonification treatment. The specific design and arrangement of the various elements of the device and the systems for fluid treatment according to the present disclosure may allow to facilitate acoustic streaming and generation of cavitation, producing sonolytic effects and defoaming not interfering with oxidizing electrodes. Furthermore, mutual interference may be reduced.

### BRIEF DESCRIPTION OF THE FIGURES

Some examples of apparatuses and/or methods will be described in the following by way of example only, and with reference to the accompanying figures, in which

FIG. 1 illustrates a first example of a device for fluid treatment;

FIG. 2 illustrates a second example of a device for fluid treatment;

FIG. 3 illustrates a first example of a system for fluid treatment;

FIG. 4 illustrates a second example of a system for fluid treatment;

FIG. 5 illustrates a third example of a system for fluid treatment;

FIG. 5 illustrates an enlarged view of a section of the system for fluid treatment illustrated in FIG. 5;

FIG. 6 illustrates a fourth example of a system for fluid treatment;

FIG. 7 illustrates a third example of a device for fluid treatment;

FIG. 8 illustrates a fifth example of a system for fluid treatment;

FIG. 9 illustrates a sixth example of a system for fluid treatment;

FIG. 10 illustrates a three-dimensional view of the system for fluid treatment illustrated in FIG. 9;

FIG. 11 illustrates a seventh example of a system for fluid treatment;

FIG. 12 illustrates a variation of the devices for fluid treatment illustrated in FIG. 11;

FIG. 13 illustrates a fourth example of a device for fluid treatment;

FIG. 14 illustrates a fifth example of a device for fluid treatment;

FIG. 15 illustrates an exemplary destruction of a pollutant in foam;

FIG. 16 illustrates an eight example of a system for fluid treatment;

FIG. 17 illustrates an alternative arrangement of the plurality of anodes and cathodes illustrated in FIG. 16;

FIG. 18 illustrates a first exemplary distribution of recesses;

FIG. 19 illustrates a second exemplary distribution of recesses; and

FIG. 20 illustrates a flowchart of an example of a method for fluid treatment.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

It is proposed to combine EO and sonolysis for the treatment of fluids such as contaminated fluids. In the following, the terms “sonolysis” and “sonication” are used synonymously. Fluids can be but are not restricted to potable water, ground water, surface water, and can also originate from contaminated soil or other solids in contact with water or other fluids, such as preconcentration fluids based on reverse osmosis, ion exchange and nano filtration. Contaminants (pollutants) can be but are not restricted to PFAS, other persistent and harmful chemicals, endocrine disruptive compounds and pharmaceutical and personal care products. Furthermore, contaminants may be one or more organism, i.e., cellular material, and/or one or more virus. Viruses and in particular microorganisms like bacteria, protozoa, algae and/or fungi may contaminate various fluids such as ground water or wastewater. For example, devices, systems and methods according to the present disclosure may be used for treating potable water, ground water, surface water, wastewater, an ion exchange regenerate solution, a nano filtration solution, a reverse osmosis solution, a foam fractionation reject solution, an aqueous film forming foam or a combination thereof.

It is proposed to use specifically designed high power ultrasonic actuators to facilitate acoustic streaming and generation of cavitation, producing sonolytic effects and defoaming not interfering with oxidizing electrodes.

It is proposed to use specifically designed actuators and electrodes in a manner to reduce mutual interference.

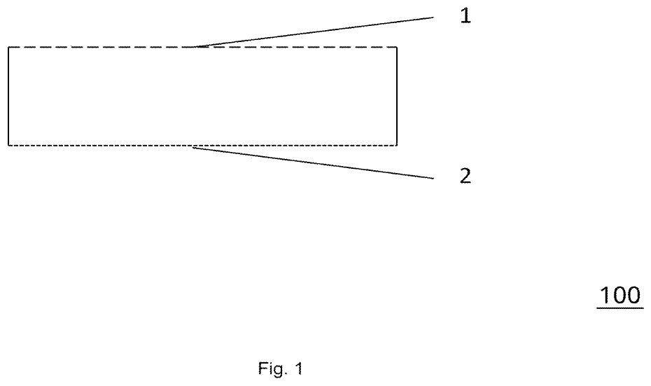

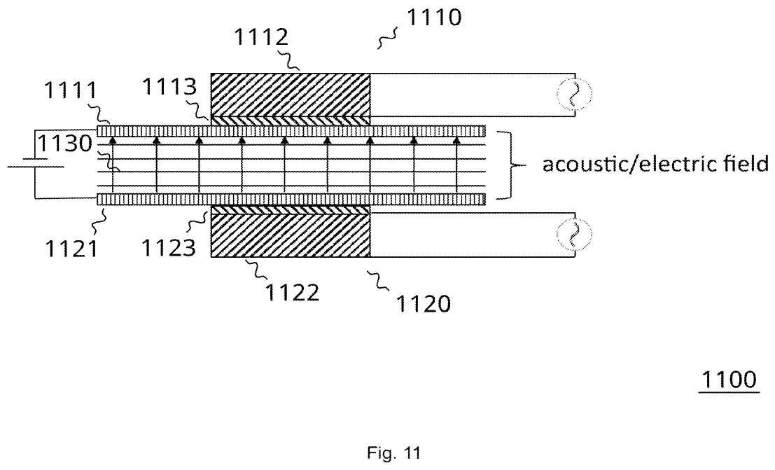

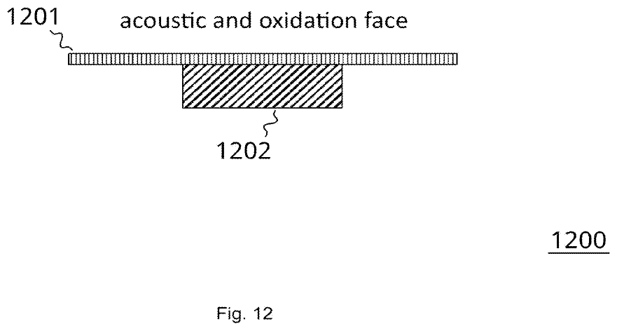

In particular, building blocks incorporating an acoustic actuator and combining electrochemical oxidation and acoustic faces are proposed. FIG. 1 illustrates an exemplary device 100 for fluid treatment. The device 100 comprises a first surface 1 for contacting and EO treatment of the fluid. The first surface 1 may be understood as an oxidation face of the building block. The device 100 further comprises a second surface 2 for contacting and sonication (sonolysis) treatment of the fluid. The second surface 2 may be understood as an acoustic face of the building block. The acoustic and the oxidation face are in communication with the fluid. The acoustic face is designed to efficiently transmit acoustic energy and may but need not be designed as a matching layer optimizing the transmission coefficient from the actuator material to the fluid. The acoustic and electrochemical oxidation faces are arranged on opposite sides of the building block, i.e., the device 100. However, it is to be noted that the present disclosure is not limited thereto. In other examples described below with reference to FIG. 11 and FIG. 12, a single surface provides the functionality of the acoustic and oxidation faces 1 and 2 illustrated in FIG. 1.

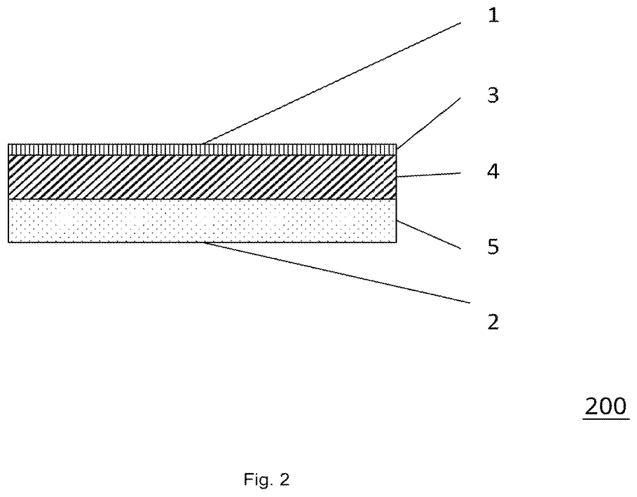

FIG. 2 illustrates a more detailed example of a device 200 for fluid treatment. Like the example of FIG. 1, the device 200 comprises a first surface 1, i.e., an oxidation face, and a second surface 2, i.e., an acoustic face, at opposite sides thereof.

The device 200 comprises an electrode layer 3 comprising at least one electrode. The first surface 1 is a surface of the electrode layer. In the example of FIG. 2, the electrode layer 3 is formed by a single electrode. However, it is to be noted that the electrode layer may alternatively formed by a plurality of laterally adjacent electrodes.

The device 200 further comprises an actuator layer 4 comprising at least one ultrasonic actuator configured to generate ultrasonic waves for the sonication treatment of the fluid. As illustrated in FIG. 2, the actuator layer 4 is arranged between the at least one electrode of the electrode layer 3 and the second surface 2. In the example of FIG. 2, the actuator layer 4 comprises a single ultrasonic actuator. However, it is to be noted that the actuator layer 4 may alternatively be formed by a plurality of laterally adjacent electrodes.

The device 200 additionally comprises an acoustic impedance matching layer 5 (also referred to as “matching layer”) configured to match an acoustic impedance of the actuator layer 4 to an acoustic impedance of the fluid contacting the second surface 2. In the example of FIG. 2, the acoustic impedance matching layer 5 is formed integrally. However, it is to be noted that the actuator layer may alternatively be formed by a plurality of individual (separate) elements formed on the actuator layer 4.

Having the oxidation and acoustic faces 1 and 2 on opposite sides of the actuator layer 4 may prevent the acoustic energy from degenerating the oxidation face 1.

One key figure for acoustic power delivery to a medium is the acoustic impedance being the product of density and speed of sound. The acoustic impedance difference at a boundary between two media is determining the transmission of energy. A transmission coefficient T indicating the efficiency of power transfer from a first material with an acoustic impedance Z¹ to a second medium of acoustic impedance Z₂ can be written as:

$$T = ( 2 * {Z}_{2} ) / ( {Z}_{1} + {Z}_{2} ) \qquad ( 1 )$$

It is known that the efficiency decreases with increasing difference between Z₁ and Z₂. The acoustic impedance Zᵢ is measured in Rayl: 1 Rayl=1 m/s·kg/m³.

According to examples of the present disclosure, electrode material with beneficial acoustic properties may be used. For example, high acoustic impedance material may be used for the oxidation face 1 (e.g., boron doped diamond with an acoustic impedance Z=63 MRayl) and material matched to the fluid (e.g., water with an acoustic impedance Z=1.5 MRayl) may be used for the acoustic face 2 in order to prevent acoustic transmission through the oxidation face 1 and foster acoustic transmission through the acoustic face 2. In other words, the at least one electrode of the electrode layer may at least in part formed of boron doped diamond. However, it is to be noted that the present disclosure is not limited thereto. Other material(s) may be used instead or additionally for the at least one electrode of the electrode layer. For example, the at least one electrode of the electrode layer may in alternative examples at least in part be formed of one or more titanium suboxide and/or one or more mixed metal oxide (e.g., based on SnO₂ and/or PbO₂).

An acoustic impedance of the acoustic impedance matching layer 5 may, e.g., be lower than the acoustic impedance of the actuator layer 4 and higher than the acoustic impedance of the fluid contacting the second surface 2. Further, as indicated above, the acoustic impedance of the acoustic impedance matching layer 5 may be lower than an acoustic impedance of the electrode layer 3. For example, the acoustic impedance of the acoustic impedance matching layer 5 may be at least five, ten, 15 or 20 times lower than the acoustic impedance of the electrode layer 3.

The acoustic impedance matching layer 5 may, e.g., at least in part be formed of one or more epoxy resin, one or more filled epoxy resin, one or more polymer and/or one or more polyurethane. However, it is to be noted that other low impedance materials may be used as well for the acoustic impedance matching layer 5.

In the example of FIG. 2, one acoustic impedance matching layer 5 is illustrated. However, it is to be noted that the present disclosure is not limited thereto. A device for fluid treatment according to the present disclosure may comprise more than one acoustic impedance matching layer (e.g., two, three or more acoustic impedance matching layers) for matching the acoustic impedance of the actuator layer 4 to the acoustic impedance of the fluid contacting the second surface 2. The plurality of acoustic impedance matching layers contact each other pairwise to form an acoustic impedance matching system.

The first surface 1 and the second surface 3 are planar surfaces in the examples of FIG. 1 and FIG. 2.

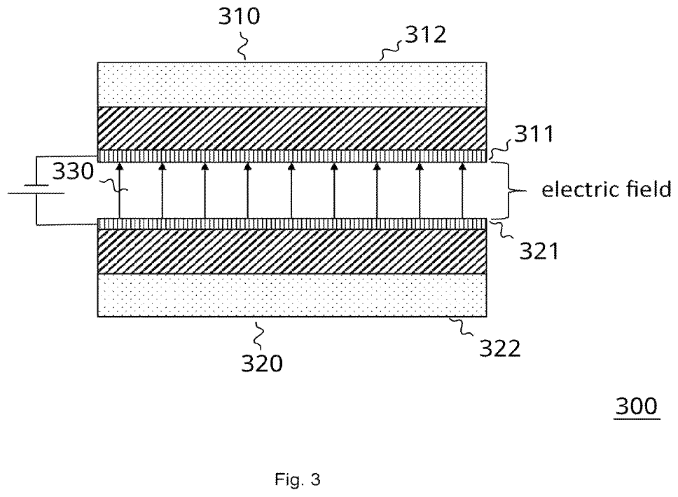

FIG. 3 illustrates a first exemplary system 300 for fluid treatment according to the present disclosure.

The system comprises a first device 310 for fluid treatment according to the present disclosure (e.g., as described above with respect to FIG. 1 and FIG. 2) and a second device 320 for fluid treatment according to the present disclosure (e.g., as described above with respect to FIG. 1 and FIG. 2). The first device 310 and the second device 320 are spaced apart from each other to form a fluid channel 330 for the fluid between the first device 310 and the second device 320. In the example of FIG. 3, the first surface 311 of the first device 310 faces the first surface 321 of the second device 320 such that the fluid 330 channel is formed between first surface 311 of the first device 310 and the first surface 321 of the second device 320.

The second faces 312 and 322 of the first device 310 and the second device 320 do not face each other in the example of FIG. 3.

The first device 310 and the second device 320 are configured to form an electric field between the first surface 311 of the first device 310 and the first surface 321 of the second device 320 for EO treatment of the fluid passing the fluid channel 330.

As indicated in FIG. 3, each of the first device 310 and the second device 320 may comprise a respective node for coupling the at least one electrode of the respective electrode layer to a respective electric potential. For example, the at least one electrode of one of the first device 310 and the second device 320 may be coupled to ground, whereas the at least one electrode of the other one of the first device 310 and the second device 320 may be coupled to an electric potential of positive or negative polarity. Alternatively, the at least one electrode of one of the first device 310 and the second device 320 may be coupled to an electric potential of positive polarity, whereas the at least one electrode of the other one of the first device 310 and the second device 320 may be coupled to an electric potential of negative polarity.

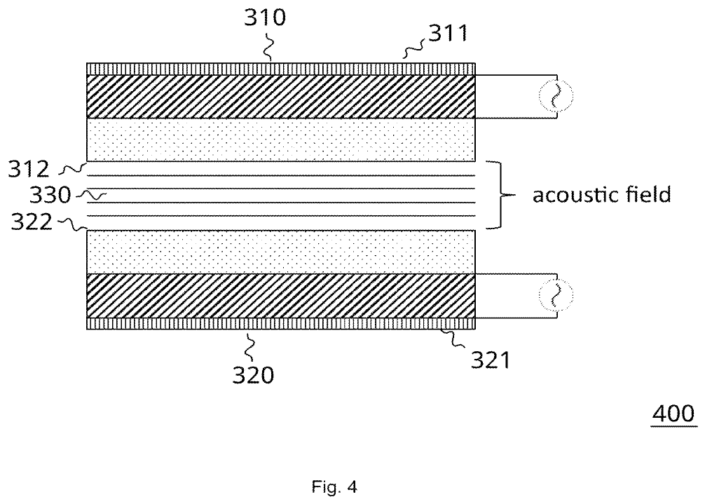

FIG. 4 illustrates an alternative second system 400 for fluid treatment according to the present disclosure. Unlike in the example of FIG. 3, the second surface 312 of the first device 310 faces the second surface 322 of the second device 320 in the example of FIG. 4 such that the fluid channel 330 is formed between second surface 312 of the first device 310 and the second surface 322 of the second device 320.

The first faces 311 and 321 of the first device 310 and the second device 320 do not face each other in the example of FIG. 4.

The first device 310 and the second device 320 are configured to emit ultrasonic waves for the sonication treatment of the fluid passing the fluid channel 330 at their respective second surface 312, 322. In particular, the respective one or more ultrasonic actuator of the respective actuator layer are configured to generate the ultrasonic waves. The respective acoustic impedance matching layer couples the ultrasonic waves into the fluid channel 330 such that an acoustic field for the sonication treatment of the fluid passing the fluid channel 330 is generated.

As indicated in FIG. 4, each of the first device 310 and the second device 320 may comprise a respective plurality of input nodes. The plurality of input nodes are each configured to receive a respective drive signal for a respective one of the at least one ultrasonic actuator in the respective actuator layer of each of the first device 310 and the second device 320. For example, the plurality of input nodes may be coupled to a respective signal generator generating the drive signals. For example, the drive signals may be periodic signals (e.g., sinusoidal signals or square wave signals).

FIGS. 3 and 4 illustrate systems comprising a pair of building blocks producing an electric or acoustic field depending on their orientation with respect to each other and external drive conditions. However, it is to be noted that the present disclosure is not limited thereto. In other examples, more than two devices for fluid treatment may be combined.

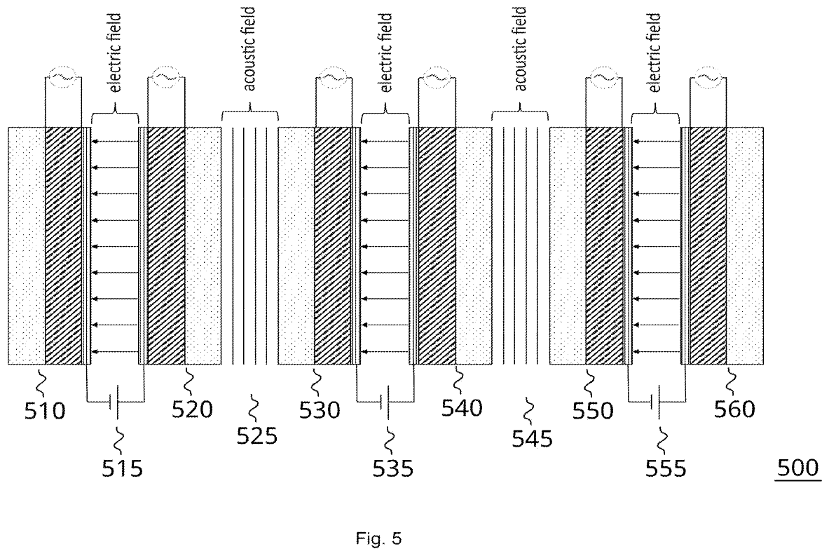

FIG. 5 illustrates a third exemplary system 500 for fluid treatment according to the present disclosure. In the example of FIG. 5, six building blocks 510, 520, 530, 540, 550 and 560 are arranged alternatingly to form alternating fluid channels 515, 525, 535, 545 and 555 for parallel or serial treatment of the fluid with EO and sonolysis. Although six devices for fluid treatment according to the present disclosure (e.g., as described above with respect to FIG. 1 and FIG. 2) are illustrated in the example of FIG. 5, it is to be noted that the present disclosure is not limited thereto. More or less than six devices for fluid treatment according to the present disclosure may be used according to other examples of the present disclosure.

The first surfaces of the devices 510 and 520 face each other similar to the example of FIG. 3 such that the fluid channel 515 is formed between the first surfaces of the devices 510 and 520. Accordingly, EO treatment of the fluid passing the fluid channel 515 is enabled.

The device 530 is spaced apart from the device 520 such that another (a second) fluid channel 525 for the fluid is formed between devices 520 and 530. The second surfaces of the devices 520 and 530 face each other similar to the example of FIG. 4 such that the fluid channel 525 is formed between the second surfaces of the devices 520 and 530. Accordingly, sonication treatment of the fluid passing the fluid channel 525 is enabled.

The other devices 540, 550 and 560 are arranged accordingly, such that EO treatment of the fluid passing the fluid channels 535 and 555 is possible, whereas sonication treatment of the fluid passing the fluid channel 545 is enabled.

As indicated above, the fluid may flow through fluid channels 515, 525, 535, 545 and 555 along the same flow direction (e.g., from the bottom to the top or vice versa) such that the fluid may be treated in parallel.

Alternatively, the fluid may flow through fluid channels 515, 525, 535, 545 and 555 along opposite flow directions. For example, a flow direction of the fluid through the channel 525 may be opposite to a flow direction of the fluid through the channel 515.

Using opposite flow directions may allow to serially expose the fluid to EO and sonification treatment. For example, the system 500 may comprise a flow control system configured to receive the fluid after passing the fluid channel 515 and direct the fluid to subsequently pass the fluid channel 525, or vice versa. Similarly, the flow control system configured to receive the fluid after passing the fluid channel 535 and direct the fluid to subsequently pass the fluid channel 545, or vice versa. The flow control system may, e.g., comprise piping and optionally one or more valves for controllably coupling the fluid channels 515, 525, 535, 545 and 555.

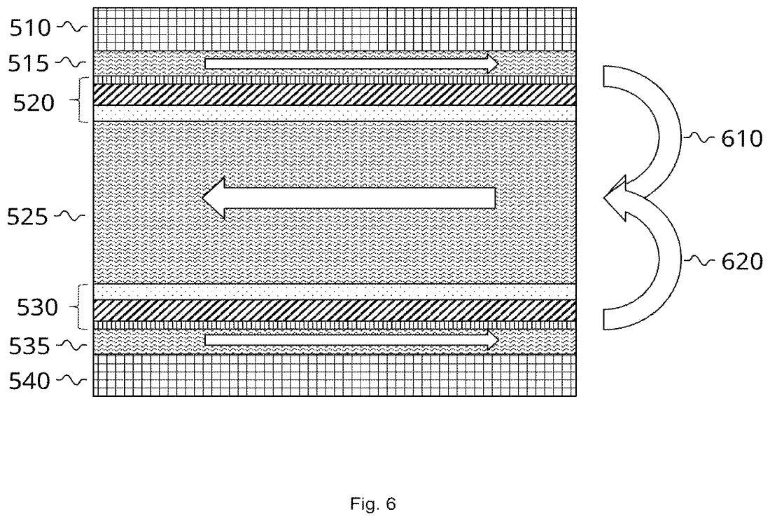

This is exemplarily illustrated in FIG. 6, which illustrates the fluid channels 515, 525, 535. As indicated in FIG. 6, after passing the respective fluid channel 515 and 535, the fluid is directed by the flow control system, which is indicated by the arrows 610 and 620 in FIG. 6, to subsequently pass the fluid channel 525. Accordingly, the fluid may first be subjected to EO treatment and subsequently to sonication treatment.

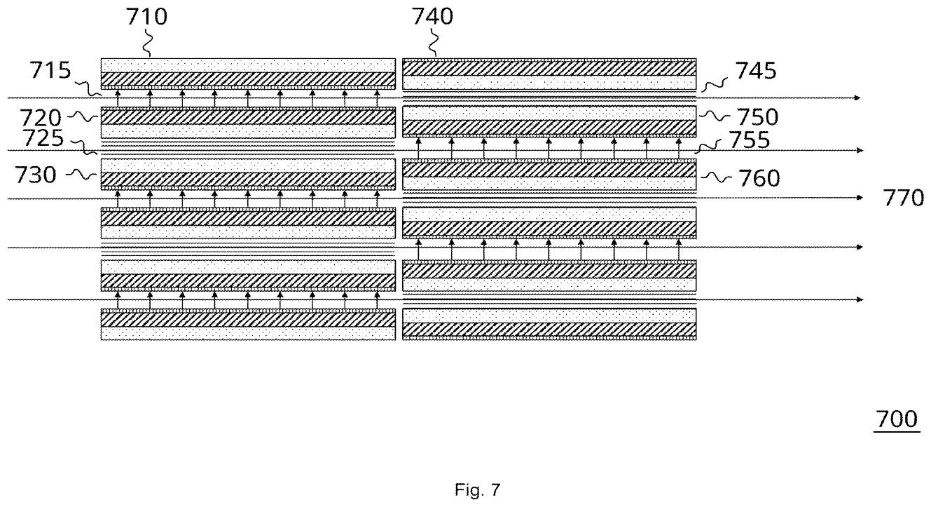

FIG. 7 illustrates a fourth exemplary system 700 for fluid treatment according to the present disclosure. In the example of FIG. 7 two alternating sets of building blocks, i.e., devices for fluid treatment according to the present disclosure (e.g., as described above with respect to FIG. 1 and FIG. 2) are arranged in series. Although each of the sets comprises six building blocks, it is to be noted that the present disclosure is not limited thereto. More or less than six devices for fluid treatment according to the present disclosure may be used according to other examples of the present disclosure. In the following, the main features of the system 700 will be described with reference to the devices 710, 720, 730, 740, 750 and 760 for fluid treatment according to the present disclosure.

The device 710 and the device 720 are spaced apart from each other to form a fluid channel 715 for the fluid between the device 710 and the device 720. The device 740 and the device 750 are spaced apart from each other to form a fluid channel 745 for the fluid between the device 740 and the device 750. The device 740 follows the device 710 along a flow direction 770 of the fluid, which is illustrated by the arrows from the left to the right of FIG. 7. Similarly, the device 750 follows the second device 720 along the flow direction 770 such that the fluid first passes through the fluid channel 715 and subsequently passes through the second fluid channel 725.

In particular, the first surface of the device 710 faces the first surface of the device 720 such that the fluid channel 715 is formed between first surface of the device 710 and the first surface of the device 720. The second surface of the device 740 faces the second surface of the device 750 such that the fluid channel 745 is formed between second surface of the device 740 and the second surface of the device 750.

Similar to what is described above, the device 710 and the device 720 are configured to form an electric field between the first surface of the device 710 and the first surface of the device 720 for EO treatment of the fluid passing the fluid channel 715, and the device 740 and the device 750 are configured to emit ultrasonic waves for the sonication treatment of the fluid passing the fluid channel 745 at their respective second surface.

Accordingly, the fluid may first be subjected to EO treatment and subsequently to sonication treatment. Likewise, the fluid may first be subjected to sonication treatment and subsequently to EO treatment.

The device 720 and the device 730 are spaced apart from each other to form a fluid channel 725 for the fluid between the device 720 and the device 730. The device 750 and the device 760 are spaced apart from each other to form a fluid channel 755 for the fluid between the device 750 and the device 760. Analogously to what is described above, the device 760 follows the device 730 along the flow direction 770 such that the fluid first passes through the fluid channel 725 and subsequently passes through the fluid channel 755

The second surface of the device 720 faces the second surface of the device 730 such that the fluid channel 725 is formed between second surface of the device 720 and the second surface of the device 730. The first surface of the device 750 faces the first surface of the device 760 such that the fluid channel 755 is formed between first surface of the device 750 and the first surface of the device 760.

Similar to what is described above, the device 720 and the device 730 are configured to emit ultrasonic waves for the sonication treatment of the fluid passing the fluid channel 725 at their respective second surface. The device 750 and the device 760 are configured to form an electric field between the first surface of the device 750 and the first surface of the device 760 for EO treatment of the fluid passing the fluid channel 755. Accordingly, the fluid is first subjected to sonication treatment and subsequently to EO treatment.

The remaining devices for fluid treatment illustrated in FIG. 7 may be operated analogously.

In the above examples, the first surface and the second surface of the devices for fluid treatment are planar. In particular, the building blocks described above are of rectangular shaped. For example, one or more plate actuator (e.g., working in thickness mode) may be used for a planar device for fluid treatment according to the present disclosure. However, the present disclosure is not limited thereto. In the following several examples with nonplanar surfaces will be described.

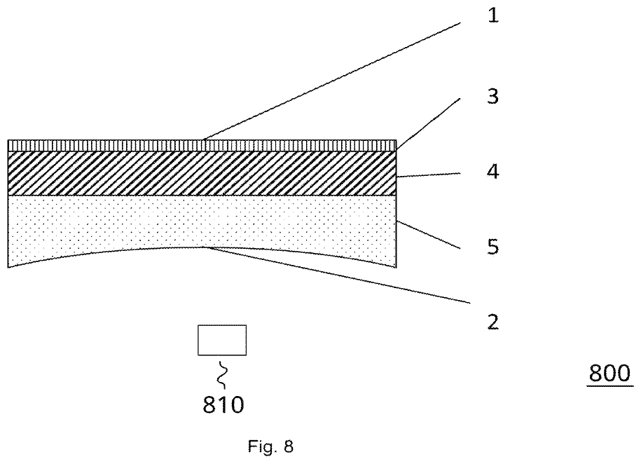

FIG. 8 illustrates a third exemplary device 800 for fluid treatment. In particular, FIG. 8 illustrates a conformal example of a device for fluid treatment according to the present disclosure. The device 800 exhibits a plano-concave shape. In the example of FIG. 8, the oxidation face 1 is planar, whereas the acoustic face 2 is concave. In other words, the second surface 2 is a concave surface and the first surface 1 is a plane surface. The actuator layer 4 is planar, i.e., the one or more ultrasonic actuator are planar. Accordingly, the acoustic impedance matching layer 5 is structured to provide the concave second surface 2.

It is to be noted that the concave surface illustrated in FIG. 8 is merely an example for a curved surface. In general, the second surface 2 may exhibit any curved (non-planar) shape. In general, the second surface 2 may at least in part be curved. This may allow to focus ultrasonic energy emitted by the second surface 2 for the sonication treatment of the fluid to a target region 810 in front of the second surface 2. For example, an acoustic pressure gain of 5 to 40 may be realized depending on the frequency of the emitted acoustic waves and the geometry (shape) of the second surface 2.

Not only the second surface 2 may be implemented conformal. Optionally also the first surface 1 may be implemented conformal. In other words, also the first surface 1 may at least in part be curved (non-planar) according to some examples.

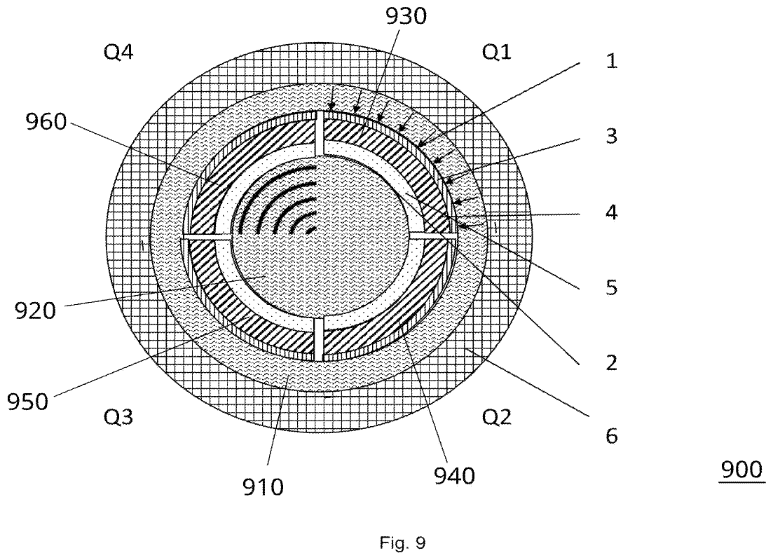

FIG. 9 illustrates another exemplary system 900 for fluid treatment. In the example of FIG. 9, the respective first and second surfaces (i.e., the inner and outer faces) of the devices for fluid treatment are cylindrical.

The system 900 comprises a pipe (tube) 6. At least an inner wall of the pipe 6 is electrically conductive. For example, the pipe 6 may be made of a non-metallic material such as a plastic and the inner wall of the pipe 6 may be metallized. In other examples, the pipe 6 as a whole may be made of metal.

The system 900 further comprises four devices 930, 940, 950 and 960 for fluid treatment according to the present disclosure (e.g., as described above with respect to FIG. 1, FIG. 2 and FIG. 8). The four devices 930, 940, 950 and 960 for fluid treatment are arranged annularly between a first fluid channel 910 and the second fluid channel 920. The four devices 930, 940, 950 and 960 for fluid treatment form a ring (hollow cylinder) separating the first fluid channel 910 from the second fluid channel 920.

The four devices 930, 940, 950 and 960 for fluid treatment are spaced apart from the inner wall of the pipe 6 to form the first fluid channel 910 between the four devices 930, 940, 950 and 960 for fluid treatment and the inner wall of the pipe 6. The respective first surface of the four devices 930, 940, 950 and 960 for fluid treatment faces the inner wall of the pipe 6.

The pipe 6 and at least one (e.g., all) of the four devices 930, 940, 950 and 960 for fluid treatment are configured to form an electric field between the respective first surface of at least one (e.g., all) of the four devices 930, 940, 950 and 960 for fluid treatment and the inner wall of the pipe 6 for EO treatment of the fluid passing the first fluid channel 910.

Further, at least one (e.g., all) of the four devices 930, 940, 950 and 960 for fluid treatment is configured to emit ultrasonic waves for the sonication treatment of the fluid passing the second fluid channel 920 at their respective second surface.

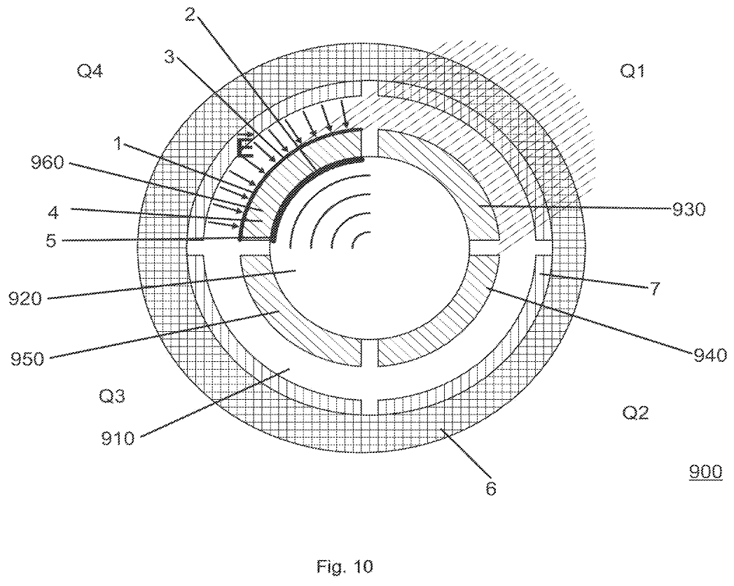

For illustrative purposes, the electric field is only shown in the first quadrant Q1 for the device 930, whereas the acoustic field is only shown in the fourth quadrant Q4 for the device 930. The cylindrical coaxial arrangement of building blocks in FIG. 9 may favorably allow to produce (generate, cause) annular flow regimes with electric and acoustic fields. FIG. 10 illustrates an alternative, three-dimensional representation of the system 900 in which both the electric field and the acoustic field are illustrated in the fourth quadrant (upper left). Furthermore, the electrically conductive inner wall 7 of the pipe 6 is highlighted in FIG. 10.

In the example of FIG. 9 and FIG. 10, exactly four devices for fluid treatment are arranged annularly between the first fluid channel 910 and the second fluid channel 920. However, it is to be noted that the present disclosure is not limited thereto. In other examples, more or less than four devices for fluid treatment may be arranged annularly between the first fluid channel 910 and the second fluid channel 920. In some examples, the system may comprise only one annular device for fluid treatment that separates the first fluid channel 910 from the second fluid channel 920.

In the above example, the oxidation face and the acoustic face are on opposite sides of the building block. However, as indicated above, the present disclosure is not limited thereto. According to examples, a single surface may provide the functionality of the acoustic and oxidation faces described above. FIG. 11 illustrates a corresponding system 1100 for fluid treatment.

The system 1100 comprises first device 1110 for fluid treatment and a second device 1120 for fluid treatment. The first device 1110 and the second device 1120 are spaced apart from each other to form a fluid channel 1130 for a fluid between the first device 1110 and the second device 1120.

The first device 1110 comprises a first electrically conductive membrane 1111 and a first ultrasonic actuator 1112 coupled to the first membrane 1111. Analogously, the second device 1120 comprises a second electrically conductive membrane 1121 and a second ultrasonic actuator 1122 coupled to the second membrane 1121. In the example of FIG. 11, one ultrasonic actuator 1112, 1122 is illustrated for each of the first device 1110 and the second device 1120. However, it is to be noted that the present disclosure is not limited thereto. In other examples, the first device 1110 and/or the second device 1120 may comprise more than one ultrasonic actuator coupled to the respective membrane.

The first membrane 1111 is arranged between the at least one first ultrasonic actuator 1112 and the fluid channel 1130. Analogously, the second membrane 1121 is arranged between the at least one second ultrasonic actuator 1122 and the fluid channel 1130. Accordingly, the first membrane 1111 and the second membrane 1121 face each other such that the fluid channel 1130 is formed between the first membrane 1111 and the second membrane 1121.

The first device 1110 and the second device 1120 are configured to form an electric field between the first membrane 1111 and the second membrane 1121 for EO treatment of the fluid passing the fluid channel 1130. As indicated in FIG. 11, the first device 1110 may comprise at least one node configured to couple the first membrane 1111 to a first electric potential, whereas the second device 1120 may comprise at least one node configured to couple the second membrane 1121 to a second electric potential different from the first electric potential.

Further, the at least one first ultrasonic actuator 1112 and the at least one second ultrasonic actuator 1122 are configured to generate ultrasonic waves for the sonication treatment of the fluid passing the fluid channel 1130.

As indicated in FIG. 11, each of the first device 1110 and the second device 1120 may comprise a respective plurality of input nodes. The plurality of input nodes are each configured to receive a respective drive signal for a respective one of the at least one first ultrasonic actuator 1112 and the at least one second ultrasonic actuator 1122. For example, the plurality of input nodes may be coupled to a respective signal generator generating the drive signals. For example, the drive signals may be periodic signals (e.g., sinusoidal signals or square wave signals).

The first device 1110 and the second device 1120 each provide a single surface, namely the surface of the respective membrane 1111, 1121, providing the functionality of the acoustic and oxidation faces described above. The EO treatment and the sonication treatment of the fluid may be driven sequentially (alternatingly) or parallel using the constant or alternating voltage sources illustrated in FIG. 11.

The membrane actuators illustrated in FIG. 11 allow to create the oxidation and acoustic faces on the same side. For example, high acoustic impedance material (e.g., boron doped diamond) may be used as a membrane itself. Or another membrane material (e.g., a metal or an oxide ceramics) may be coated with a suitable electrode material. As an example, the membrane structures 1111 and 1121 may be: a) straight boron doped diamond plates, b) thin 5-15 μm thick boron doped diamond films on niobium or c) thin 5-15 μm thick boron doped diamond films. In other words, at least one of the first membrane 1111 and the second membrane 1121 may at least in part be formed of boron doped diamond. However, it is to be noted that the present disclosure is not limited thereto. Other material(s) may be used instead or additionally for the first membrane 1111 and/or the second membrane 1121.

In the example of FIG. 11, an isolating layer 1113 is arranged between the first membrane 1111 and the at least one first ultrasonic actuator 1112 for electrically isolating the first membrane 1111 and the at least one first ultrasonic actuator 1112. Analogously, an isolating layer 1123 is arranged between the second membrane 1121 and the at least one second ultrasonic actuator 1122 for electrically isolating the second membrane 1121 and the at least one second ultrasonic actuator 1122. For example, the isolating layers 1113 and 1123 may be formed by an electrically isolating glue. However, it is to be noted that the isolating layers 1113 and 1123 are optional and may be omitted according to some examples of the present disclosure. An according implementation of a device 1200 for fluid treatment is illustrated in FIG. 12. In the example of FIG. 12, the device 1200 comprises an electrically conductive membrane 1201 and an ultrasonic actuator 1202 directly coupled to the membrane 1201. No isolating layer is used between the membrane 1201 and the ultrasonic actuator 1202. Like in the example of FIG. 11, the device 1200 may comprise more than one ultrasonic actuator coupled to the membrane 1201.

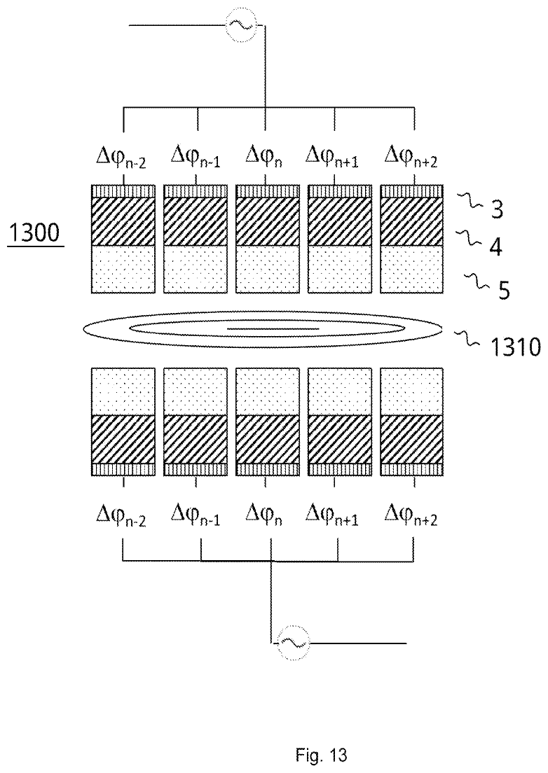

In the above examples, the layers of the building blocks were shown as integral elements. However, building blocks and actuators may consist of a multitude of sub-elements according to examples of the present disclosure. A sub-element can be driven with a multitude of signals with phase delays and optionally amplitude shifts to create electronic focusing effects. Phase delays can be static or varying creating moving electronic focus. Moving electronic focus can be used to shift high pressure areas creating better coverage of the medium to be treated. This is exemplarily illustrated in FIG. 13 illustrating another exemplary device 1300 for fluid treatment in the upper part of FIG. 13. The exemplary device 1300 is replicated in the lower part of FIG. 13. In the example of FIG. 13, the electrode layer 3 is structured and comprises a plurality of individual elements, which may be individually or commonly coupled to an electric potential. Similarly, the acoustic impedance matching layer 5 is structured and comprises a plurality of individual elements, which may be individually shaped.

The actuator layer 4 comprises a plurality of ultrasonic actuators. In the example of FIG. 13, five ultrasonic actuators are illustrated. However, it is to be noted that the present disclosure is not limited thereto. More or less than five ultrasonic actuators may be used according to examples of the present disclosure. It is to be noted that the lateral spacing of the subelements in FIG. 13 is merely for illustrative purposes. For example, the sub-elements may be spaced regularly as illustrated in FIG. 13 or irregularly.

The plurality of ultrasonic actuators are configured to emit phase and/or amplitude shifted ultrasonic waves for focusing ultrasonic energy emitted by the second surface for the sonication treatment of the fluid to a target region 1310 in front of the second surface.

The device 1300 further comprises a plurality of input nodes each configured to receive a respective drive signal for a respective one of the plurality of ultrasonic actuators. In the example of FIG. 13, the drive signals are phase shifted with respect to each other (indicated by their respective phase Δφᵢ). In other examples, the drive signals may alternatively or additionally be amplitude shifted.

In other words, FIG. 13 illustrates a building block consisting of sub-elements with individual electronic contacts enabling individual phase delays and creation of electronic focus.

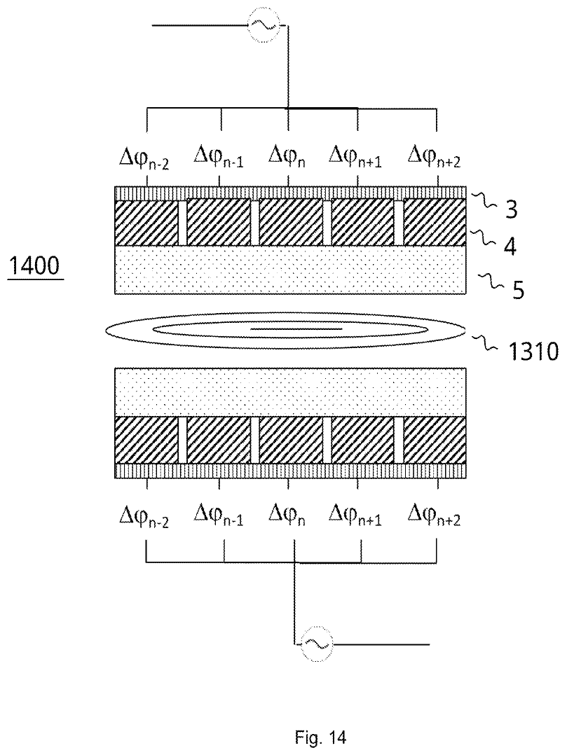

In the example of FIG. 13, all layers of the device 1300 are segmented. However, it is to be noted that the present disclosure is not limited thereto. In other examples, only one layer such as the actuator layer 4 may comprise individual elements. This is exemplarily illustrated in FIG. 14 showing an alternative device 1400. Unlike in the example of FIG. 13, the electrode layer 3 and the acoustic impedance matching layer 5 are formed integrally in the example of FIG. 14. However, the actuator layer 4 comprises a plurality of individual ultrasonic actuators.

According to the present disclosure, EO treatment and sonolysis treatment may be used in parallel or sequentially (see above and below examples). In both cases, sonolysis (sonification treatment) may be intensified by bubbles created by EO (e.g., H₂ and O₂ as products of electrolysis of PFAS). The bubbles serve as intentionally produced cavitation nuclei thus lowering the threshold of cavitation and thus reducing required power. In other words, EO treatment of the fluid may be such that bubbles are created in the fluid, the bubbles serving as cavitation nuclei in the sonication treatment of the fluid.

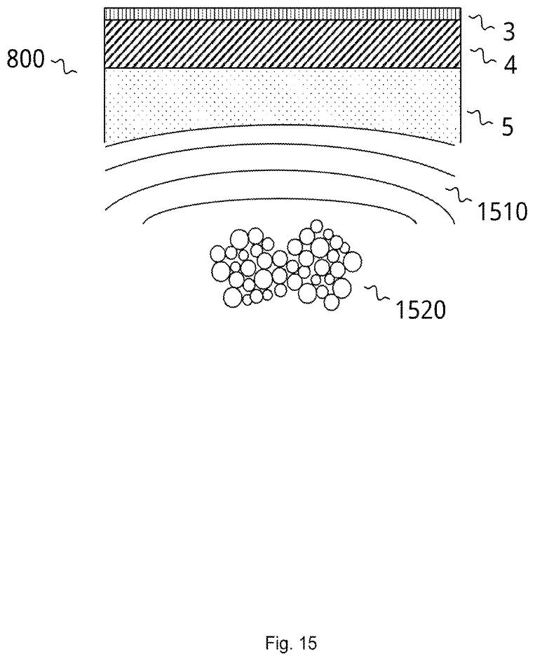

Sonolysis may be used not only to destroy PFAS in liquid components of the fluid but also to treat foam created by EO or other processes. Foams may in general be destroyed based on acoustic effects in the ultrasonic frequency range. Accordingly, sonolysis based on, e.g., high intensity ultrasound may be used according to the present disclosure for destruction of chemicals in foams created, e.g., during EO. In other words, an intensity and/or a frequency of the ultrasonic waves for the sonication treatment of the fluid may be such that a pollutant in at least one of a liquid component and a foam component of the fluid is destroyed by the ultrasonic waves. Further, the intensity and/or the frequency of the ultrasonic waves for the sonication treatment of the fluid may be such that a foam component of the fluid is destroyed by the ultrasonic waves. As described above, the pollutant may, e.g., be one or more PFAS. However, the present disclosure is limited thereto. Other pollutants may be destroyed (removed) as well (see above examples). FIG. 15 exemplarily illustrates the emission of ultrasonic waves 1510 by the above described device 800 for fluid treatment to destroy foam 1520.

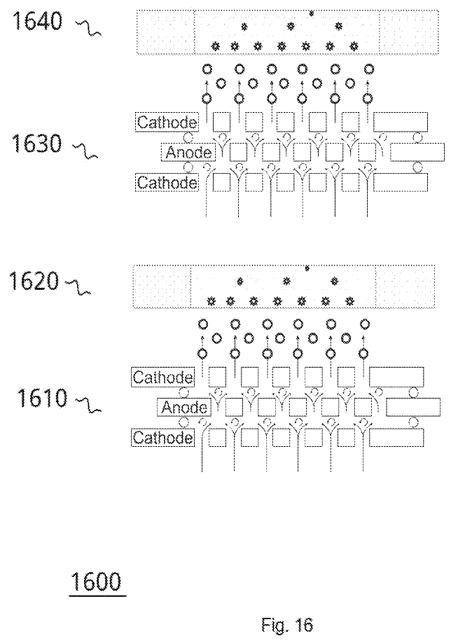

FIG. 16 illustrates another system 1600 for fluid treatment. The system 1600 comprises a plurality of anodes and cathodes 1610 arranged alternatingly to form a respective electric field between succeeding ones of the plurality of anodes and cathodes 1610 for EO treatment of a fluid. The plurality of anodes and cathodes 1610 are stacked on top of each other along the flow direction of the fluid (from the bottom to the top in the example of FIG. 16). Recesses are formed in each of the plurality of anodes and cathodes to enable passage of the fluid through plurality of anodes and cathodes 1610 along the flow direction of the fluid. A respective spacer is arranged between succeeding ones of the plurality of anodes and cathodes 1610 to space the succeeding ones of the plurality of anodes and cathodes 1610 apart from each other along the flow direction of the fluid.

The system 1600 may comprise a plurality of nodes configured to couple a respective one of the plurality of anodes and cathodes 1610 to a respective electric potential.

The system 1600 further comprises an actuator layer 1620 comprising at least one ultrasonic actuator configured to generate ultrasonic waves for sonication treatment of the fluid. The actuator layer 1620 is formed on (arranged on top of) the plurality of anodes and cathodes 1610 and follows the plurality of anodes and cathodes 1610 along the flow direction of the fluid. In other words, the plurality of anodes and cathodes 1610 and the actuator layer 1620 are stacked such that the actuator layer 1620 follows the plurality of anodes and cathodes 1610 along the flow direction of the fluid. In still other words, the actuator layer 1620 is arranged in series with the plurality of anodes and cathodes 1610 and follows the plurality of anodes and cathodes 1610 along the flow direction of the fluid.

Additionally, the system 1600 comprises another plurality of anodes and cathodes 1630 arranged alternatingly to form a respective electric field between succeeding ones of the other plurality of anodes and cathodes 1630 for the EO treatment of the fluid. The other plurality of anodes and cathodes 1630 is formed on (arranged on top of) the actuator layer 1620 and follows the actuator layer 1620 along the flow direction of the fluid. In other words, the other plurality of anodes and cathodes 1630 and the actuator layer 1620 are stacked such that the other plurality of anodes and cathodes 1630 follows the actuator layer 1620 along the flow direction of the fluid. In still other words, the other plurality of anodes and cathodes 1630 is arranged in series with the actuator layer 1620 and follows the actuator layer 1620 along the flow direction of the fluid.

The system 1600 may comprise a plurality of nodes configured to couple a respective one of the other plurality of anodes and cathodes 1630 to a respective electric potential.

Still further, the system 1600 comprises another actuator layer 1640 comprising at least one ultrasonic actuator configured to generate ultrasonic waves for the sonication treatment of the fluid. The other actuator layer 1640 is formed on (arranged on top of) the other plurality of anodes and cathodes 1630 and follows the other plurality of anodes and cathodes 1630 along the flow direction of the fluid. In other words, the other plurality of anodes and cathodes 1630 and the other actuator layer 1640 are stacked such that the other actuator layer 1640 follows the other plurality of anodes and cathodes 1630 along the flow direction of the fluid. In still other words, the other actuator layer 1640 is arranged in series with the other plurality of anodes and cathodes 1630 and follows the other plurality of anodes and cathodes 1630 along the flow direction of the fluid.

In other words, the system of FIG. 16 comprises building blocks consisting of flow through electrodes and ultrasound actuators combined in a stack formation. As fluid (e.g., water) flows through the electrodes, bubbles are generated, which are then destroyed by the ultrasound transducers.

Although the example of FIG. 16 illustrates four alternating building blocks of flow through electrodes and ultrasound actuators stacked on top of each other, it is to be noted that the present disclosure is not limited thereto. Any number of electrode building blocks and any number of actuator layers may be arranged alternatingly. Further, it is to be noted that the present disclosure is not limited to using one anode arranged between two cathodes along the flow direction of the fluid. In general, any number of anodes and cathodes may be arranged alternatingly. For example, the number of anodes and cathodes arranged alternatingly may be an odd number (3, 5, 7, etc.). In other examples, the number of anodes and cathodes arranged alternatingly may be an even number (2, 4, 6, etc.).

The actuator layer 1620 and also any other actuator layer of the system 1600 may comprise one annular ultrasonic actuator as illustrated in FIG. 16. However, the present disclosure is not limited thereto. In other examples, the actuator layer 1620 and also any other actuator layer of the system 1600 may comprise a plurality of ultrasonic actuators arranged annularly.

Similarly to what is described above, the plurality of ultrasonic actuators of the respective actuator layer may be configured to emit phase and/or amplitude shifted ultrasonic waves for focusing ultrasonic energy emitted for the sonication treatment of the fluid to a target region within the annular arrangement of the plurality of ultrasonic actuators. The system 1600 may accordingly comprise a plurality of input nodes each configured to receive a respective drive signal for a respective one of the plurality of first ultrasonic actuators, wherein the drive signals are phase and/or amplitude shifted with respect to each other.

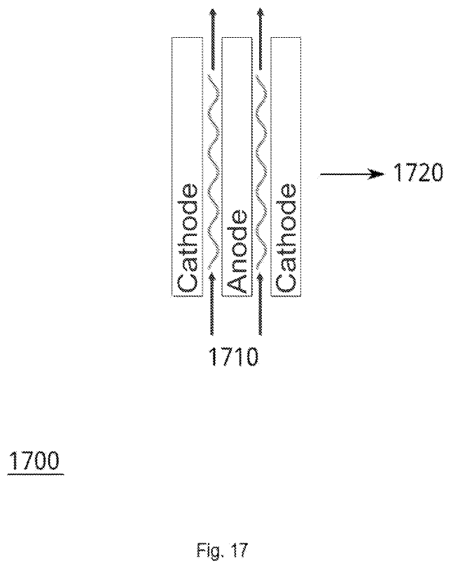

In other words, FIG. 16 illustrates an exemplary building block configuration of macroporous flow through electrodes in series with ultrasound transducers. However, the present disclosure is not limited to flow through electrodes. FIG. 17 illustrates an alternative configuration of the plurality of anodes and cathodes 1700. In the example of FIG. 17, the plurality of anodes and cathodes 1700 are arranged parallel to each other along a direction 1720 perpendicular to the flow direction of the fluid 1710. The plurality of anodes and cathodes 1700 are spaced apart from each other such that a respective fluid channel along the flow direction of the fluid 1710 is formed between succeeding ones of the plurality of anodes and cathodes 1700.

The electrodes for EO treatment may be configured in flow through (macroporous) or flow by (parallel plate) geometries according to the examples of FIG. 16 and FIG. 17. The electrode geometry influences mass transfer of contaminants (pollutants) to the surface for degradation, as well as formation of secondary reactive species, such as hydroxyl radicals. Therefore, contaminant degradation rates may be improved by modifying the electrode geometry. Further optimization of the flow through geometry may be made by adjusting macropore sizes, number and orientation. The flow by geometry may be optimized by modifying the inter-plate distance and surface geometry.

At least one of the of anodes and cathodes of the respective plurality of the anodes and cathodes may at least in part be formed of boron doped diamond. However, it is to be noted that the present disclosure is not limited thereto. Other material(s) may be used instead or additionally for the anodes and cathodes.

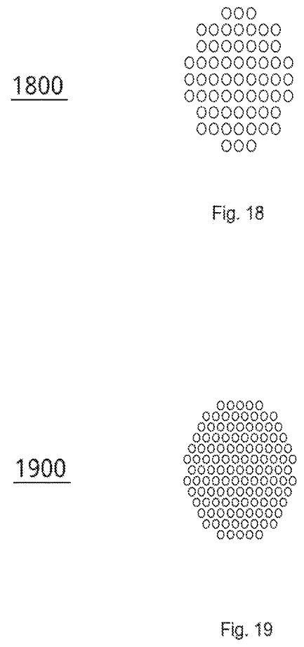

FIG. 18 and FIG. 19 illustrate two exemplary flow through cell macropore sizes and orientations 1800 and 1900 which may be used for the anodes and cathodes illustrated in FIG. 16. The recess distributions illustrated in FIG. 18 and FIG. 19 may allow to improve the flow through anodes and cathodes illustrated in FIG. 16.

In the foregoing, various exemplary devices and systems for fluid treatment using at least one ultrasonic actuator configured to generate ultrasonic waves for sonification treatment of the fluid are described. It is to be noted that the at least one ultrasonic actuator in the respective example may be configured to generate ultrasonic waves at one or more predefined frequency (or frequency range). For example, the at least one ultrasonic actuator in the respective example may be configured to generate ultrasonic waves with a frequency higher than 1 kHz and lower than 2 MHz. The at least one ultrasonic actuator in the respective example may be configured to (e.g., simultaneously or sequentially) generate ultrasonic waves at a first frequency and ultrasonic waves at a second frequency, wherein a ratio of the second frequency to the first frequency is 1.5 or higher (e.g., 2 or higher). The first frequency may, e.g., be lower than 100 kHz. The second frequency may, e.g., be higher than 100 kHz. Ultrasonic waves with a frequency significantly below 100 kHz allow to set the fluid in motion and to mix the fluid. Ultrasonic waves with a frequency significantly higher than 100 kHz allow to generate a high acoustic pressure and, hence, to generate cavitation nuclei for destroying pollutants (e.g., PFASs, organisms or viruses) and foam components of the fluid. For example, the at least one ultrasonic actuator in the respective example may be configured to generate ultrasonic waves with a frequency between 20 kHz and 60 kHz (e.g., 20, 30, 40, 50 or 60 kHz) and alternatively or additionally ultrasonic waves with a frequency between 350 kHz and 2 MHz (e.g., 350, 600, 700, 1000 or 2000 kHz).

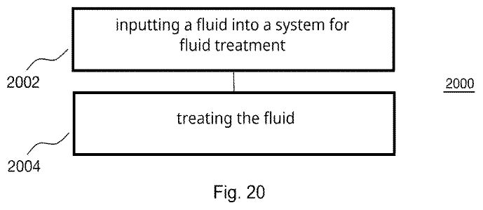

For further illustrating the proposed fluid treatment, FIG. 20 illustrates a flowchart of a method 2000 for fluid treatment. The method 2000 comprises inputting 2002 a fluid (e.g., potable water, ground water, surface water, wastewater, an ion exchange regenerate solution, a nano filtration solution, a reverse osmosis solution, a foam fractionation reject solution, an aqueous film forming foam or a combination thereof) into a system for fluid treatment according to any one of the above examples. Further, the method 2000 comprises treating 2004 the fluid using the system for fluid treatment.

The method 2000 may allow improved treatment/purification of the fluid by combining EO treatment and sonification treatment as described above.

More details and aspects of the method 2000 are explained in connection with the proposed technique or one or more examples described above (e.g., FIGS. 1 to 19). The method 2000 may comprise one or more additional optional features corresponding to one or more aspects of the proposed technique or one or more examples described above.

Focusing (ultrasonic) transducers as used in some of the examples may produce high energy density rather at a distance from the transducer. Therefore, the shape of the transducer may direct the sound and, hence, the high energy away from the transducer. Examples of the present disclosure may enable ultrasonic defoaming and, hence, prevent poorly soluble chemicals (e.g., PFAS) from concentration in foam, where it is not accessible for treatment. Integration of EO and acoustics in the same building block according to the present disclosure may facilitate small high density units for scaling up from lab to industrial scale. According to the present disclosure, high impedance mismatch between the oxidation face (e.g., made at least in part of diamond) and the backside of the actuator may be used for increased acoustic output. The optimized EO electrode design according to the present disclosure may allow for superior mass transport of contaminants to the surface and therefore enhanced degradation rates.

The present disclosure may enable PFAS remediation in, e.g., soil or ground water. Further, the present disclosure may in general enable chemical destruction, especially of persistent chemicals. The present disclosure may further enable destruction of organisms, in particular microorganisms, and viruses in, e.g., ground water or wastewater. The present disclosure may enable treatment of contaminated fluids like sewage from industry, landfills or mines. Additionally, the present disclosure may enable treatment of ground water or potable water. Still further, the present disclosure may enable treatment of stormwater from contaminated areas

The aspects and features described in relation to a particular one of the previous examples may also be combined with one or more of the further examples to replace an identical or similar feature of that further example or to additionally introduce the features into the further example.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

1. A device for fluid treatment, comprising:
a first surface for contacting and electrochemical oxidation treatment of the fluid;
a second surface for contacting and sonication treatment of the fluid, wherein the first sur-face and the second surface are arranged on opposite sides of the device;
an electrode layer comprising at least one electrode, wherein the first surface is a surface of the electrode layer;
an actuator layer comprising at least one ultrasonic actuator configured to generate ultrasonic waves for the sonication treatment of the fluid, wherein the actuator layer is arranged between the at least one electrode and the second surface; and
an acoustic impedance matching layer configured to match an acoustic impedance of the actuator layer to an acoustic impedance of the fluid, wherein the acoustic impedance matching layer and the electrode layer are formed on opposite sides of the actuator layer.

2. (canceled)

3. The device of claim 1, wherein the at least one electrode is at least in part formed of boron doped diamond.

4. (canceled)

5. The device of claim 1, wherein an acoustic impedance of the acoustic impedance matching layer is lower than the acoustic impedance of the actuator layer and higher than the acoustic impedance of the fluid.

6. The device of claim 1, wherein an acoustic impedance of the acoustic impedance matching layer is lower than an acoustic impedance of the electrode layer.

7. The device of claim 6, wherein the acoustic impedance of the acoustic impedance matching layer is at least five times lower than the acoustic impedance of the electrode layer.

8. The device of claim 1, wherein the actuator layer comprises a plurality of ultrasonic actuators configured to emit phase and/or amplitude shifted ultrasonic waves for focusing ultrasonic energy emitted by the second surface for the sonication treatment of the fluid to a target region in front of the second surface.

9. The device of claim 8, wherein the device further comprises a plurality of input nodes each configured to receive a respective drive signal for a respective one of the plurality of ultrasonic actuators, wherein the drive signals are phase and/or amplitude shifted with respect to each other.

10. The device of claim 1, further comprising at least one node configured to couple the at least one electrode to an electric potential.

11. The device of claim 1, wherein the at least one ultrasonic actuator is configured to generate ultrasonic waves with one or more predefined frequency.

12. The device of claim 11, wherein the at least one ultrasonic actuator is configured to generate ultrasonic waves at a first frequency and ultrasonic waves at a second frequency, wherein a ratio of the second frequency to the first frequency is 1.5 or higher.

13. The device of claim 1, wherein the first surface and the second surface are planar surfaces.

14. The device of claim 1, wherein the second surface is at least in part curved for focusing ultrasonic energy emitted by the second surface for the sonication treatment of the fluid to a target region in front of the second surface.

15. The device of claim 14, wherein the second surface is a concave surface.

16. The device of claim 14, wherein first surface is at least in part curved.

17. A system for fluid treatment, comprising:
a first device according to claim 1; and
a second device according to claim 1 spaced apart from the first device to form a fluid channel for the fluid between the first device and the second device,
wherein either the first surface of the first device faces the first surface of the second de-vice or the second surface of the first device faces the second surface of the second device.

18. The system of claim 17, wherein the first surface of the first device faces the first surface of the second device such that the fluid channel is formed between first surface of the first device and the first surface of the second device, and wherein the first device and the second device are configured to form an electric field between the first surface of the first device and the first surface of the second device for electrochemical oxidation treatment of the fluid passing the fluid channel.

19. The system of claim 18, further comprising:
a third device spaced apart from the first device to form another fluid channel for the fluid between the first device and the third device, wherein the third comprises:
a first surface for contacting and electrochemical oxidation treatment of the fluid;
a second surface for contacting and sonication treatment of the fluid, wherein the first sur-face and the second surface are arranged on opposite sides of the device;
an electrode layer comprising at least one electrode, wherein the first surface is a surface of the electrode layer;
an actuator layer comprising at least one ultrasonic actuator configured to generate ultrasonic waves for the sonication treatment of the fluid, wherein the actuator layer is arranged between the at least one electrode and the second surface; and
an acoustic impedance matching layer configured to match an acoustic impedance of the actuator layer to an acoustic impedance of the fluid, wherein the acoustic impedance matching layer and the electrode layer are formed on opposite sides of the actuator layer,
wherein the second surface of the first device faces the second surface of the third device, and
wherein first device and the third device are configured to emit ultrasonic waves for the sonication treatment of the fluid passing the other fluid channel at their respective second surface.

20. The system of claim 17, wherein the second surface of the first device faces the second surface of the second device such that the fluid channel is formed between second surface of the first device and the second surface of the second device, and wherein first device and the second device are configured to emit ultrasonic waves for the sonication treatment of the fluid passing the fluid channel at their respective second surface.

21. The system of claim 20, further comprising:
a third device spaced apart from the first device to form another fluid channel for the fluid between the first device and the third device, wherein the third comprises:
a first surface for contacting and electrochemical oxidation treatment of the fluid;
a second surface for contacting and sonication treatment of the fluid, wherein the first sur-face and the second surface are arranged on opposite sides of the device;
an electrode layer comprising at least one electrode, wherein the first surface is a surface of the electrode layer;
an actuator layer comprising at least one ultrasonic actuator configured to generate ultrasonic waves for the sonication treatment of the fluid, wherein the actuator layer is arranged between the at least one electrode and the second surface; and
an acoustic impedance matching layer configured to match an acoustic impedance of the actuator layer to an acoustic impedance of the fluid, wherein the acoustic impedance matching layer and the electrode layer are formed on opposite sides of the actuator layer,
wherein the first surface of the first device faces the first surface of the third device, and
wherein first device and the second device are configured to are configured to form an electric field between the first surface of the first device and the first surface of the third device for electrochemical oxidation treatment of the fluid passing the other fluid channel.

22. The system of claim 19, wherein a flow direction of the fluid through the fluid channel is equal to a flow direction of the fluid through the other fluid channel.

23. The system of claim 19, wherein a flow direction of the fluid through the fluid channel is opposite to a flow direction of the fluid through the other fluid channel.

24. The system of claim 23, further comprising a flow control system configured to:
receive the fluid after passing one of the fluid channel and the other fluid channel; and
direct the fluid to subsequently pass the other one of the fluid channel and the other fluid channel.

25. A system for fluid treatment, comprising:
a first device according to claim 1;
a second device according to claim 1 spaced apart from the first device to form a first fluid channel for the fluid between the first device and the second device;
a third device according to claim 1;
a fourth device according to claim 1 spaced apart from the third device to form second fluid channel for the fluid between the third device and the fourth device;
wherein the third device follows the first device along a flow direction of fluid and the fourth device follows the second device along the flow direction of fluid such that the fluid first passes through the first fluid channel and subsequently passes through the second flu-id channel,
wherein either the first surface of the first device faces the first surface of the second de-vice such that the first fluid channel is formed between first surface of the first device and the first surface of the second device or the second surface of the first device faces the second surface of the second device such that the first fluid channel is formed between second surface of the first device and the second surface of the second device,
wherein, if the first surface of the first device faces the first surface of the second device, the second surface of the third device faces the second surface of the fourth device such that the second fluid channel is formed between second surface of the third device and the second surface of the fourth device, and
wherein, if the second surface of the first device faces the second surface of the second device, the first surface of the third device faces the first surface of the fourth device such that the second fluid channel is formed between first surface of the third device and the first surface of the fourth device.

26. The system of claim 25, wherein, if the first surface of the first device faces the first surface of the second device:
the first device and the second device are configured to form an electric field between the first surface of the first device and the first surface of the second device for electrochemical oxidation treatment of the fluid passing the first fluid channel, and the third device and the fourth device are configured to emit ultrasonic waves for the sonication treatment of the fluid passing the second fluid channel at their respective second surface.

27. The system of claim 25, wherein, if the second surface of the first device faces the second surface of the second device:
the first device and the second device are configured to emit ultrasonic waves for the sonication treatment of the fluid passing the first fluid channel at their respective second surface, and
the third device and the fourth device are configured to form an electric field between the first surface of the third device and the first surface of the fourth device for electrochemical oxidation treatment of the fluid passing the second fluid channel.

28-60. (canceled)
